(19) United States
(12) Patent Application Publication
(10) Pub. No.: US 2009/0052954 A1
(43) Pub. Date: Feb. 26, 2009

(54) ELECTROPHOTOGRAPHIC ENDLESS BELT, ELECTROPHOTOGRAPHIC APPARATUS, AND ELECTROPHOTOGRAPHIC ENDLESS BELT MANUFACTURING METHOD

(76) Inventors: Ryota Kashiwabara, Shizuoka-ken (JP); Tsunenori Ashibe, Kanagawa-ken (JP)

Correspondence Address: FITZPATRICK CELLA HARPER & SCINTO, 30 ROCKEFELLER PLAZA, NEW YORK, NY, 10112, US

(21) Appl. No.: 11/577,439

(22) PCT Filed: Dec. 12, 2005
(86) PCT No.: PCT/JP05/23189

§ 371 Date: Apr. 18, 2007

(30) Foreign Application Priority Data
Dec. 13, 2004 (JP) 2004-359884

(51) Int. Cl. G03G 15/16

(52) U.S. Cl. 399/313

(57) ABSTRACT

The object of the present invention is to provide an electrophotographic endless belt exhibiting high uniformity in transfer and high stability in running, and an electrophotographic apparatus having the electrophotographic endless belt. The present invention provides: an electrophotographic endless belt formed of a thermoplastic resin composition, characterized in that, assuming that the maximum heating shrinkage factor when a slice of the electrophotographic endless belt is hot-pressed in a temperature range higher than a melting point of the thermoplastic resin composition by 10° C. to 120° C. is L (%), 15≦L≦80 is established, and assuming that the maximum tensile rupture distortion attained by performing a heating tensile test using a slice hot-pressed at a temperature giving the maximum heating shrinkage factor in a temperature range of 80° C. to 200° C. is S, 0.10≦(S+1)/L≦0.17 is established; an electrophotographic apparatus having the electrophotographic endless belt; and a method of manufacturing the electrophotographic endless belt.

### TECHNICAL FIELD

The present invention relates to an electrophotographic endless belt, such as an intermediate transferring belt or a transfer material conveying belt for use in an electrophotographic apparatus, an electrophotographic apparatus having an electrophotographic endless belt, and an electrophotographic endless belt manufacturing method.

### BACKGROUND ART

An electrophotographic apparatus using an electrophotographic endless belt (also referred to as an electrophotographic seamless belt), such as an intermediate transferring belt or a transfer material conveying belt, is effective as a color electrophotographic apparatus in which a plurality of component color images are successively superimposed one upon the other and transferred to output a color image (multi-color image).

Examples of an electrophotographic endless belt manufacturing method include a tube extrusion molding method, an inflation molding method, a centrifugal molding method, a blow molding method, and an injection molding method.

Of the above-mentioned molding methods, the blow molding method, which uses a mold, is advantageous in that it is possible to stabilize the external dimensions. In particular, in a stretch blow molding method, which is a kind of blow molding method, molecular orientation occurs as a result of stretching, so that it is advantageously possible to enhance the strength of a molding (electrophotographic endless belt). Further, the blow molding method, which provides high repeatability, makes it possible to obtain moldings of a uniform quality in a stable manner. Further, it allows high speed molding.

The stretch blow molding method involves a step in which a high pressure gas is caused to flow into a preform to expand the preform. It is, however, rather difficult to expand the preform uniformly.

In particular, when molding/producing an electrophotographic endless belt by stretch blow molding, it is necessary for the thickness of the molding (electrophotographic endless belt) to be much smaller as compared with that of a molding obtained by an ordinary stretch blow molding (e.g., 250 μm or less). The smaller the thickness of the molding, the easier it is for unevenness in thickness and surface recesses due to non-uniformity in the expansion of the preform to be generated. Further, due to non-uniformity in the expansion of the preform, there may be generated a difference in peripheral length between the right-hand and left-hand openings of the electrophotographic endless belt.

When an electrophotographic endless belt exhibiting unevenness in thickness and surface recesses and a great difference in peripheral length between the right-hand and left-hand openings is used as an intermediate transferring belt or a transfer material conveying belt, a defect, such as color drift, is generated in the output image due to the low uniformity in transfer and the low stability in the running of the electrophotographic endless belt.

Techniques for molding/producing an electrophotographic endless belt by the stretch blow molding method are disclosed in Japanese Patent Application Laid-Open No. H05-061230, Japanese Patent Application Laid-Open No. 2001-018284 and Japanese Patent Application Laid-Open No. H03-089357, etc.

### DISCLOSURE OF THE INVENTION

However, in the above-mentioned techniques, there is conducted no stretch blow molding in which the relationship between the stretchability of the material used and the stretch blow magnification is taken into consideration. Thus, the above-mentioned problems have not been solved to a sufficient degree yet.

For example, when a material exhibiting markedly low or high stretchability with respect to the stretch blow magnification is used, distortion is generated in the surface of the molding (electrophotographic endless belt) due to unevenness in stress at the time of molding. As a result, a recess may be generated in the surface of the molding. If a surface recess of the molding is not to be observed at a glance, distortion may exist within the molding. In such cases, the same problem may be involved as that in the case where a surface recess is to be observed at a glance.

It is an object of the present invention to provide an electrophotographic endless belt in which the above-mentioned problems have been solved and which provides a high level of transfer uniformity and high running stability, and an electrophotographic apparatus having such an electrophotographic endless belt.

Another object of the present invention is to provide a method of manufacturing an electrophotographic endless belt which provides a high level of transfer uniformity and high running stability.

The present invention provides an electrophotographic endless belt formed of a thermoplastic resin composition, characterized in that: assuming that a maximum heating shrinkage factor when a slice of the electrophotographic endless belt is hot-pressed in a temperature range higher than a melting point of the thermoplastic resin composition by 10° C. to 120° C. is L (%), 15≦L≦80 is established; and assuming that a maximum tensile rupture distortion attained by performing a heating tensile test using a slice hot-pressed at a temperature giving the maximum heating shrinkage factor in a temperature range of 80° C. to 200° C. is S, 0.10≦(S+1)/L≦0.17 is established.

Further, the present invention provides an electrophotographic apparatus having the electrophotographic endless belt.

Further, the present invention provides an electrophotographic endless belt manufacturing method for manufacturing the electrophotographic endless belt, the method including a step of conducting stretch blow molding by using the thermoplastic resin composition.

In accordance with the present invention, it is possible to provide an electrophotographic endless belt which provides a high level of transfer uniformity and high running stability, and an electrophotographic apparatus having such an electrophotographic endless belt.

Further, in accordance with the present invention, it is possible to provide a method of manufacturing an electrophotographic endless belt which provides a high level of transfer uniformity and high running stability.

### BRIEF DESCRIPTION OF THE DRAWINGS

FIG. 1 is a diagram for illustrating how a belt slice extends in the longitudinal direction and the lateral direction thereof.

FIG. 2 is a diagram for illustrating a method of measuring heating shrinkage factor.

FIG. 3 is a diagram for illustrating an injection molding step.

FIG. 4 is a diagram showing an example of an injection molding machine.

FIG. 5 is a diagram for illustrating a heating step.

FIG. 6 is a diagram for illustrating a stretch blow molding step.

FIG. 7 is a diagram for illustrating a stretch blow molding step.

FIG. 8 is a diagram for illustrating a stretch blow molding step.

FIG. 9 is a diagram for illustrating a step for cutting off the upper and lower portions of a stretch molding.

FIG. 10 is a diagram schematically showing a construction example of a full-color electrophotographic apparatus using an electrophotographic endless belt according to the present invention as an intermediate transferring belt.

FIG. 11 is a diagram schematically showing a construction example of a full-color electrophotographic apparatus using an electrophotographic endless belt according to the present invention as a transfer material conveying belt.

FIG. 12 is a diagram schematically showing another construction example of a full-color electrophotographic apparatus using an electrophotographic endless belt according to the present invention as the intermediate transferring belt.

FIG. 13 is a diagram for illustrating a method of deriving Vrmax/Vrmin.

### BEST MODE FOR CARRYING OUT THE INVENTION

As stated above, the electrophotographic endless belt of the present invention is an electrophotographic endless belt formed of a thermoplastic resin composition. In the present invention, a “thermoplastic resin composition” refers to a resin composition exhibiting thermoplasticity. Thus, if, for example, a material is a resin composition consisting of a mixture of a thermoplastic resin and a thermoplastic resin powder, that material is to be regarded as a kind of “thermoplastic resin composition” as referred to in the present invention as long as the material as a whole exhibits thermoplasticity.

Examples of the thermoplastic resin used in the present invention include the following substances. These can be used singly or in a combination of two or more of them.

Examples of the thermoplastic resin include a polyolefine (polyethylene, polypropylene, or the like), polystyrene, an acrylic resin, an ABS resin, a polyester (PET, PBT, PEN, PAR, or the like), polycarbonate, a sulfur-containing resin (polysulfone, polyether sulfone, polyphenylene sulfide, or the like), a fluorine-containing resin (polyvinylidene fluoride, polyethylene-tetrafluoro ethylene copolymer, or the like), polyurethane, a silicone resin, a ketone resin, polyvinylidene chloride, thermoplastic polyimide, polyamide, and modified polyphenylene oxide.

Furthermore, one obtained by modifying or copolymerizing the resin can be also used in the present invention.

Assuming that the maximum heating shrinkage factor of the electrophotographic endless belt of the present invention when a slice thereof is hot-pressed in a temperature range which is 10 to 120° C. higher than the melting point of the thermoplastic resin composition used in the electrophotographic endless belt is L (%), 15≦L≦80 is established. The slice of the electrophotographic endless belt means a sheet-like piece cut off from an electrophotographic endless belt in a predetermined size. Hereinafter, it will be also referred to as a “belt slice”.

If the maximum heating shrinkage factor L (%) is in the range: 15≦L≦80, it means that, when molding/producing an electrophotographic endless belt, the thermoplastic resin composition constituting the material thereof has been stretched by an appropriate stretch magnification. When the stretch magnification is too small, a sufficient molecular orientation is not effected in the X-direction (circumferential direction) and the Y-direction (axial direction), so it is impossible to obtain an electrophotographic endless belt having sufficient strength. When the stretch magnification is too large, the molecular orientation occurs to an excessive degree, so that separation easily occurs on the front surface or the back surface of the electrophotographic endless belt.

The above maximum hot contraction coefficient L (%) means a maximum value out of L₁₀ to L₁₂₀ when a melting point to be used for an electrophotographic endless belt is denoted as an mp (° C.) and

the hot contraction coefficient upon hot-pressing a belt section at an mp+10 (° C.) is denoted as L₁₀ (%),
the hot contraction coefficient upon hot-pressing a belt section at an mp+20 (° C.) is denoted as L₂₀ (%),
the hot contraction coefficient upon hot-pressing a belt section at an mp+30 (° C.) is denoted as L₃₀ (%),
the hot contraction coefficient upon hot-pressing a belt section at an mp+40 (° C.) is denoted as L₄₀ (%),
the hot contraction coefficient upon hot-pressing a belt section at an mp+50 (° C.) is denoted as L₅₀ (%),
the hot contraction coefficient upon hot-pressing a belt section at an mp+60 (° C.) is denoted as L₆₀ (%),
the hot contraction coefficient upon hot-pressing a belt section at an mp+70 (° C.) is denoted as L₇₀ (%),
the hot contraction coefficient upon hot-pressing a belt section at an mp+80 (° C.) is denoted as L₈₀ (%),
the hot contraction coefficient upon hot-pressing a belt section at an mp+90 (° C.) is denoted as L₉₀ (%),
the hot contraction coefficient upon hot-pressing a belt section at an mp+100 (° C.) is denoted as L₁₀₀ (%),
the hot contraction coefficient upon hot-pressing a belt section at an mp+110 (° C.) is denoted as L₁₁₀ (%), and
the hot contraction coefficient upon hot-pressing a belt section at an mp+120 (° C.) is denoted as L₁₂₀ (%). In addition, a temperature during a hot press at which a maximum hot contraction coefficient L (%) is indicated is represented as a maximum hot contraction coefficient temperature T_{L} (° C.).

The size of the belt slices used as the measurement samples for the measurement of heating shrinkage factor may be determined as appropriate according to the specifications of the measurement device, etc. The present inventors selected the following size: 10 cm (in the longitudinal direction)×10 cm (in the lateral direction). The longitudinal direction of the belt slice coincides with the circumferential direction of the electrophotographic endless belt, and the lateral direction of the belt slice coincides with the axial direction of the electrophotographic endless belt.

In the following, a method of measuring the melting point of a thermoplastic resin composition will be described.

The measurement was performed according to ASTM D3418-82, and a differential scanning calorimeter (DSC measurement device) DSC-7 (manufactured by PerkinElmer, Inc.) was used as the measurement device.

Not less than 2 mg and not more than 10 mg (5 mg is preferable) of a thermoplastic resin composition (measurement sample) was weighed accurately. This was put in an aluminum pan, and measurement was conducted within a measurement temperature range of not lower than 30° C. and not higher than 300° C. and at a temperature rise rate of 10° C./min. An empty aluminum pan was used as a reference.

In the temperature rise process, there was obtained a DSC curve for the thermoplastic resin composition within the temperature range of 30° C. to 300° C. The peak temperature (endothermic peak) in the DSC curve was regarded as the melting point of the thermoplastic resin composition. When there exist a plurality of peaks in the DSC curve, the maximum of the peak temperatures was regarded as the melting point of the thermoplastic resin composition.

Next, a method of measuring heating shrinkage factor L₁₀ will be described.

First, temperature adjustment is effected such that the temperature of the upper and lower plates of a hot press device (manufactured by Kansai roll co., ltd.) for conducting the above-mentioned hot pressing is mp+10 (° C.).

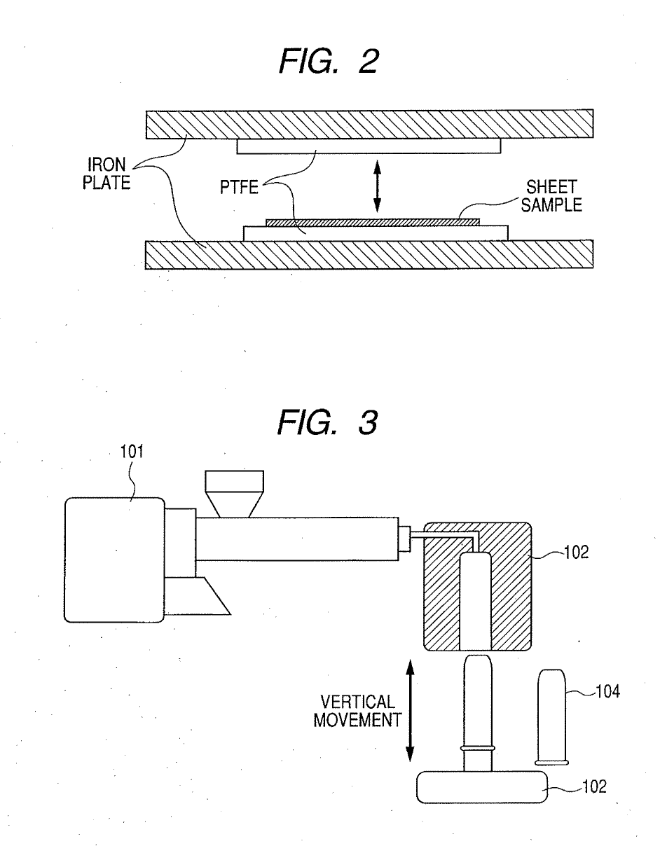

Next, as shown in FIG. 2, a belt slice is sandwiched between iron plates (with a thickness of 5 mm or more) and PTFE (polytetrafuluoroethylene) sheets, and the whole is sandwiched between the upper and lower plates of the hot press device. When the belt slice has a satisfactory releasing property with respect to the iron plates, it is not always necessary to provide the PTFE sheets. When, as a result of sandwiching between the upper and lower plates of the hot press device what is obtained by sandwiching the belt slice between the iron plates and the PTFE sheets, the temperature of the upper and lower plates is deviated from mp+10 (° C.), the whole is left to stand until the temperature of mp+10 (° C.) is reached again.

In five minutes or more after the temperature of the upper and lower plates of the hot press device has become mp+10 (° C.), the belt slice sandwiched between the iron plates and the PTFE sheets is removed from the upper and lower plates of the hot press device, and is cooled immediately thereafter. It is possible to use a cold press device for the cooling.

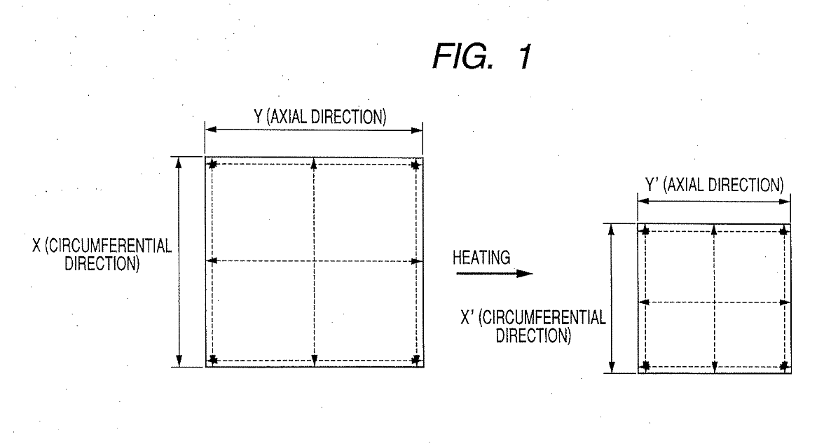

When the iron plates have been cooled to a temperature not higher than 30° C., the belt slice sandwiched between the iron plates and the PTFE sheets is extracted, and the longitudinal length X′ (cm) and the lateral length Y′ (cm) of the belt slice are measured (see FIG. 1). When the belt slice extracted does not maintain the original square configuration but has been distorted, the average of the longitudinal lengths at both ends and the central length of the belt slice is regarded as the longitudinal length thereof, and the average of the lateral lengths at both ends and the central length of the belt slice is regarded as the lateral length thereof. When an electrophotographic endless belt is molded/produced by stretching a thermoplastic resin composition biaxially in the longitudinal direction and the lateral direction, if a slice (belt slice) of the endless belt is hot-pressed, the molecular orientation in the belt slice is removed, and the belt slice shrinks in the longitudinal and lateral directions.

As stated above, the longitudinal length X′ (cm) and the lateral length Y′ (cm) of the belt slice after hot pressing are measured, and then the heating shrinkage factor L₁₀ is calculated by the following equation:

L₁₀=[{(X+Y)−(X′+Y′)}/(X+Y)]×100(%)

(In the above equation, X is the longitudinal length (cm) of the belt slice before hot pressing, and Y is the lateral length (cm) of the belt slice before hot pressing. In the above case, X=10, and Y=10.)

Heating shrinkage factors L₂₀ to L₁₂₀ can be measured in the same manner as in the case of the heating shrinkage factor L₁₀ except that mp+10 (° C.) is changed to mp+20 (° C.) to mp+120 (° C.).

When obtaining the maximum heating shrinkage factor L (%) of an electrophotographic endless belt, it is necessary to cut off twelve belt slices in total from the electrophotographic endless belt to measure the heating shrinkage factors L₂₀ to L₁₂₀.

Further, in the electrophotographic endless belt of the present invention, when the maximum tensile rupture distortion attained by performing a heating tensile test using the above hot-pressed slice within the temperature range of 80 to 200° C. is S (which is dimensionless and is also expressed as S×100(%)), 0.10≦(S+1)/L≦0.17 is established.

If (S+1)/L is less than 0.10, it means that the stretchability of the thermoplastic resin composition constituting the material is insufficient with respect to the stretch magnification (i.e., hard to stretch). When the stretchability of the material is insufficient with respect to the stretch magnification, separation is likely to occur on the front surface or the back surface of the electrophotographic endless belt molded/produced through stretching. On the other hand, if (S+1)/L exceeds 0.17, it means that the stretchability of the thermoplastic resin composition constituting the material is excessive with respect to the stretch magnification. When the stretchability of the material is excessive with respect to the stretch magnification, unevenness in thickness and a surface recess are likely to be generated in the electrophotographic endless belt molded/produced through stretching.

The above maximum tensile destroy strains mean a maximum value out of S₈₀ to S₂₀₀ when the belt sections hot-pressed at the maximum hot contraction coefficient temperature T_{L} (° C.) in the above procedure each are extended and denoted as follows:

the tensile destroy strain upon tensile+80 (° C.) of S₈₀;
the tensile destroy strain upon tensile+90 (° C.) of S₉₀;
the tensile destroy strain upon tensile+100 (° C.) of S₁₀₀;
the tensile destroy strain upon tensile+110 (° C.) of S₁₁₀;
the tensile destroy strain upon tensile+120 (° C.) of S₁₂₀;
the tensile destroy strain upon tensile+130 (° C.) of S₁₃₀;
the tensile destroy strain upon tensile+140 (° C.) of S₁₄₀;
the tensile destroy strain upon tensile+150 (° C.) of S₁₅₀;
the tensile destroy strain upon tensile+160 (° C.) of S₁₆₀;
the tensile destroy strain upon tensile+170 (° C.) of S₁₇₀;
the tensile destroy strain upon tensile+180 (° C.) of S₁₈₀;
the tensile destroy strain upon tensile+190 (° C.) of S₁₉₀; and
the tensile destroy strain upon tensile+200 (° C.) of S₂₀₀. However, when the thermoplastic composition to be used for an electrophotographic endless belt at the temperature within the range of 80° C. to 200° C. is decomposed, the maximum tensile destroy strain S is determined only from the temperature range in which the resin is not decomposed. For example, when the thermoplastic resin is decomposed at 190° C. or higher, the maximum tensile destroy strain S is a maximum value out of S₈₀ to S₁₈₀.

In the present invention, tensile rupture distortion is measured according to JIS K7161 (1994). The present inventors used a tensile test machine (trade name: Tensilon UCT-500) manufactured by ORIENTEC, Co., LTD as the measurement device for the tensile rupture distortion measurement. The upper limit of the in-furnace temperature of the tensile test machine was set at 300° C. The inter-chuck distance was set at 20 mm. The rate of pulling was set at 500 mm/min.

For tensile rupture distortion measurement, there is used a slice hot-pressed at the maximum heating shrinkage temperature (T_{L}) (a shrunk slice; hereinafter also referred to as the “shrunk belt slice”). The size of the shrunk belt slice may be determined as appropriate according to the specifications of the measurement device, etc. The present inventors selected the following size: 10 cm (in the longitudinal direction)×2 cm (in the lateral direction). To obtain a shrunk belt slice of a desired size, a belt slice somewhat larger than the desired size (before shrinkage) is shrunk by hot pressing at the maximum heating shrinkage temperature (T_{L}), and then a shrunk belt slice of the desired size is cut off therefrom. When using the above-mentioned tensile test machine, the preferred range for the thickness of the shrunk belt slice is not less than 70 μm but not more than 190 μm from the viewpoint of accuracy in measurement. However, also in the case of a thickness out of this range, it is possible to perform accurate measurement by changing the jig and measurement device as appropriate.

In the following, a method of measuring tensile rupture distortion S₈₀ will be described.

First, with the start-up of the measurement device, the in-furnace temperature is set at 80° C. After the in-furnace temperature has attained 80° C., pre-heating is effected for five minutes.

Next, the longitudinal ends of a shrunk belt slice are held by chucks, and the temperature is raised again to 80° C. After the temperature rise, heating is effected for five minutes.

Thereafter, the tensile test is started, and is continued until the shrunk belt slice is severed to derive the tensile rupture distortion S₈₀.

The distance between the chucks holding the shrunk belt slice before the start of the tensile test (inter-chuck distance) corresponds to the “gauge length” in JIS K7161.

The value of “S+1” in (S+1)/L indicates how many times as large the inter-chuck distance when the shrunk belt slice is pulled until it is severed (the gauge length after the tensile test) is as the inter-chuck distance before the start of the tensile test (the initial gauge length). The tensile rupture distortion is a value obtained by dividing the “increment” of the gauge length by the initial gauge length.

The tensile rupture distortions S₉₀ to S₂₀₀ can also be measured in the same manner as in the case of the tensile rupture distortion S₈₀ except that the above temperature of 80° C. is changed to 90 to 200° C.

In the present invention, it is desirable that the volume resistivity of the electrophotographic endless belt be not less than 1.0×10³ Ω·cm but not more than 9.0×10¹⁴ Ω·cm. When the volume resistivity is too low, a sufficient transfer electric field cannot be obtained, and image defects, such as white patches and roughness, are likely to be generated in the output image. On the other hand, when the volume resistivity is too high, it is also necessary to enhance the transfer voltage, resulting in an increase in the size of the transfer power source, in the size of the electrophotographic apparatus as a whole, and in cost.

The volume resistivity of an electrophotographic endless belt was measured as follows.

As the resistance meter of the measurement device, an ultra high resistance meter R8340A (manufactured by ADVANTEST CORPORATION) was used, and as the sample box, an ultra high resistance measurement sample box TR42 (manufactured by ADVANTEST CORPORATION) was used. The main electrode had a diameter of 50 mm, and the guard ring electrode had an inner diameter of 70 mm and an outer diameter of 75 mm.

The measurement sample was prepared as follows.

First, a circular slice with a diameter of 56 mm was obtained from an electrophotographic endless belt by a stamping machine or a sharp cutter. An electrode was provided overall by a Pt—Pd evaporation film on one side of the circular slice obtained. On the other side, there were provided a main electrode and a guard ring electrode by a Pt—Pd evaporation film. The Pt—Pd evaporation film was obtained by conducting evaporation for two minutes by Mild Sputter E 1030 (manufactured by Hitachi, Ltd.). The slice which had undergone evaporation was used as the measurement sample.

The measurement atmosphere was 23° C./55% RH, and the measurement sample was left to stand in the atmosphere for 12 hours or more in advance. In the measurement, discharge was performed for 10 seconds, charging was performed for 30 seconds, and measurement was performed for 30 seconds, with the voltage applied being 100V. The applied voltage may be changed within the range allowing measurement according to the resistance of the electrophotographic endless belt.

The electrical resistance of an electrophotographic endless belt can be controlled by causing the thermoplastic resin composition constituting the material to contain various conductive agents. Examples of the conductive agents include various metals and metal salts, an ionic conductive agent of low molecular weight such as glycol, an ionic conductive high molecular compound containing ether linkages, hydroxyl groups, etc. in the molecules, and a high molecular compound exhibiting electronic conductivity. Of those, an ionic conductive high molecular compound is preferable. Examples of the ionic conductive high molecular compound include polyetherester amide.

Further, in the present invention, it is desirable for the elastic modulus of the electrophotographic endless belt to be not less than 800 MPa but not more than 3000 MPa. When the elastic modulus of the electrophotographic endless belt is too small, expansion/contraction of the electrophotographic endless belt is likely to be generated during image formation, and color drift may be generated in the output image. When the elastic modulus of the electrophotographic endless belt is too large, the mark (bending mark) of the portion (bent portion) wrapped around a suspension roller in the electrophotographic apparatus is likely to remain, and a streak-like defect due to the bending mark may be generated in the output image.

The elastic modulus of an electrophotographic endless belt was measured as follows.

First, a measurement sample with a length (as measured in the circumferential direction of the electrophotographic endless belt) of 100 mm and a width of 20 mm was cut off from the electrophotographic endless belt, and the average thickness thereof (t (mm)) was measured. The average thickness (t) of the measurement sample is the average of thickness values obtained at five points in the measurement sample. Then, the measurement sample was attached to a tensile test device (trade name: Tensilon UCT-500, manufactured by ORIENTEC, Co., LTD).

Next, a tensile test was conducted at a measurement interval of 50 mm and a testing rate of 5 mm/min, and the elongation and stress were recorded by a recorder. The stress (f(N)) at 1% was read and the elastic modulus was derived from the following equation:

Elastic modulus=((f/(20×t))×1000(MPa)

This measurement was performed five times, and the average value of the five measurements was adopted as the elastic modulus of the electrophotographic endless belt.

In the present invention, it is desirable for the average thickness of the electrophotographic endless belt to be not less than 40 μm but not more than 250 μm. When the average thickness is not less than 40 μm, it is possible to suppress generation of wrinkles and a reduction in durability due to low mechanical strength when the belt is stretched for use within the electrophotographic apparatus. When the average thickness is not more than 250 μm, it is possible to suppress an increase in cost due to an increase in material, and generation of a scattered image due to contraction of the outer surface as a result of an increase in a difference in peripheral speed between the inner and outer surfaces at the stretched portion. Further, it is also possible to suppress a deterioration in bending durability, an increase in driving torque due to excessive rigidity, and an increase in cost due to an increase in the size of the electrophotographic apparatus main body.

The average thickness of the electrophotographic endless belt was measured as follows.

With a dial gauge of a minimum value of 1 μm, measurement was performed on the center of the electrophotographic endless belt and on positions at 50 mm from both sides thereof over the entire periphery at five equal circumferential intervals. The measurement was performed at 3×5=15 points in total. The average value of the thickness values obtained at those fifteen points was adopted as the average thickness of the electrophotographic endless belt.

An electrophotographic endless belt according to the present invention can be prepared by stretch blow molding using a thermoplastic resin composition as mentioned above.

In the following, an example of the stretch blow molding method will be described with reference to FIGS. 3 through 9. In the examples and comparative examples described below, electrophotographic endless belts were prepared by a stretch blow molding method as described below.

FIG. 3 is a diagram for illustrating an injection molding step.

First, a preform 104, which is a test-tube-shaped molding of FIG. 3, is formed by injection molding. The preform 104 is obtained by injecting a thermoplastic resin composition into an injection molding mold 102 by an injection molding machine 101. The lower mold of the injection molding mold 102 is capable of vertical movement.

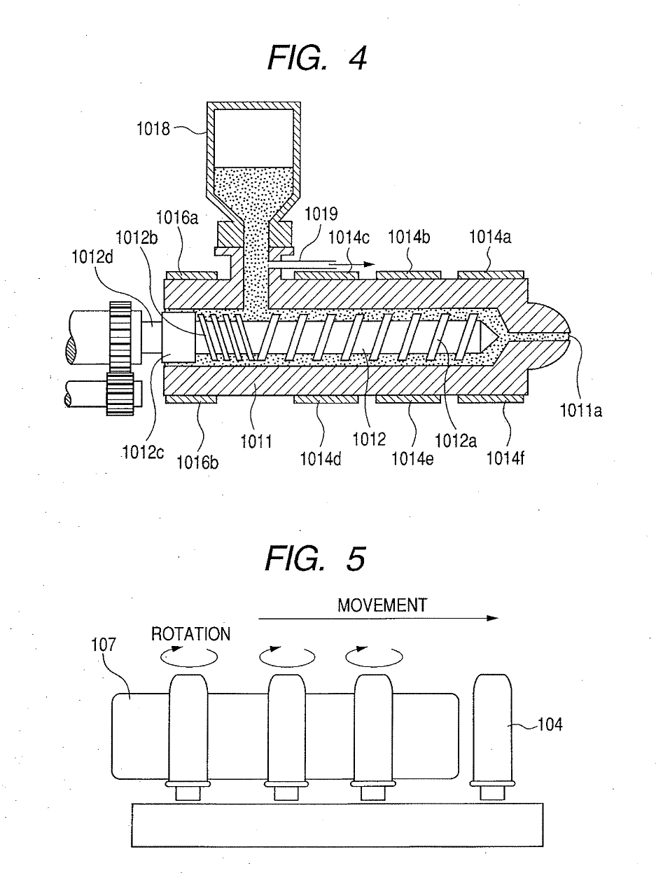

FIG. 4 is a diagram showing an example of the injection molding machine.

In FIG. 4, reference symbol 1011 indicates a heating cylinder, which contains an injection screw 1012. Reference symbols 1014a, 1014b, 1014c, 1014d, 1014e and 1014f indicate first heaters for heating the heating cylinder 1011 and melting a thermoplastic resin composition supplied. Reference symbols 1016a and 1016b indicate second heaters for keeping the thermoplastic resin composition at a predetermined temperature level; the second heaters are arranged at the rear end of the heating cylinder. The reason for keeping the thermoplastic resin composition at a predetermined temperature level is to keep the heating cylinder 1011 in a sealed state (as described below). Further, to perform energization control on the first heaters 1014a, 1014b, 1014c, and 1014d, and the second heaters 1016a and 1016b, the heating cylinder 1011 is equipped with sensors (not shown) for measuring the temperatures of different portions of the heating cylinder 1011.

The injection screw 1012 is equipped with blades 1012a for kneading the thermoplastic resin composition supplied and then injecting the same. On the rear end side of the injection screw 1012, there are provided blades 1012b directed oppositely to the blades 1012a. A proximal end portion 1012c of the injection screw 1012 is connected to a screw driving shaft 1012d.

Reference symbol 1018 indicates a hopper for supplying the thermoplastic resin composition into the heating cylinder 1011. It is connected to a supply passage of the heating cylinder 1011. The supply passage is equipped with an opening/closing shutter (not shown). By opening the opening/closing shutter, the thermoplastic resin composition is supplied from the hopper 1018 to the heating cylinder 1011.

Reference symbol 1019 indicates a vacuum pumping tube mounted to the supply passage; the vacuum pumping tube is connected to a vacuum pump (not shown).

The operation of the injection molding machine shown in FIG. 4 is as follows.

The first heaters 1014a, 1014b, 1014c, and 1014d, and the second heaters 1016a and 1016b heat the heating cylinder 1011 into which the thermoplastic resin composition has been supplied. First, as a result of this heating, the portion of the thermoplastic resin composition on the forward end side of the heating cylinder 1011 is melted. The molten thermoplastic resin composition blocks a nozzle opening 1011a at the forward end of the heating cylinder 1011. Then, the portion of thermoplastic resin composition on the rear end side of the heating cylinder 1011 is also melted.

When a sensor detects that the temperature inside the heating cylinder 1011 has reached a predetermined temperature, the vacuum pump operates, and the air within the heating cylinder 1011 is sucked.

Further, by the rotation of the injection screw 1012, the thermoplastic resin composition is kneaded, and at the same time, weighing of the thermoplastic resin composition is effected. Subsequently, the thermoplastic resin composition is compressed and injected to be poured into the injection molding mold.

Between the step of heating the heating cylinder 1011 and the step of injecting the thermoplastic resin composition, the interior of the heating cylinder 1011 is kept in a sealed state to prevent oxidation and discoloration of the thermoplastic resin composition. As stated above, the nozzle opening 1011a at the forward end of the heating cylinder 1011 is blocked by the molten thermoplastic resin composition. Further, the gap between the rear end portion of the heating cylinder 1011 and the injection screw 1012 is blocked by the molten thermoplastic resin composition forced to the rear end side of the heating cylinder 1011 by the blades 1012b.

FIG. 5 is a diagram for illustrating a heating step conducted after the injection molding step.

In the heating step, the preform 104 is heated while continuously moving within a heating furnace 107 to be heated to a desired temperature. The heating conditions may be set as appropriate according to the composition of the thermoplastic resin composition, the construction of the blow mold, the blowing condition, etc.

While it may be a hot air furnace, a warm air furnace or the like, the heating furnace 107 is preferably one having one or a plurality of heaters on both sides or one side thereof. While it is possible to adopt as the heating method radiation heating, halogen heater heating, infrared heating, electromagnetic induction heating, etc., halogen heater heating, infrared heating, and electromagnetic induction heating are preferable since they allow heating at low cost. In the examples and comparative examples described below, halogen heater heating was adopted.

Further, by imparting a difference in temperature between the upper and lower portions of the heater, it is possible to intentionally impart a temperature difference to the preform, thereby achieving a satisfactory moldability at the time of blow molding conducted thereafter. It should be noted, however, that the temperature difference between the upper and lower portions is preferably 50° C. or less, and more preferably, 30° C. or less. When the temperature difference is too large, the temperature difference inside the preform becomes too large, so there may be generated unevenness in the expansion-shaping property at the time of blow molding.

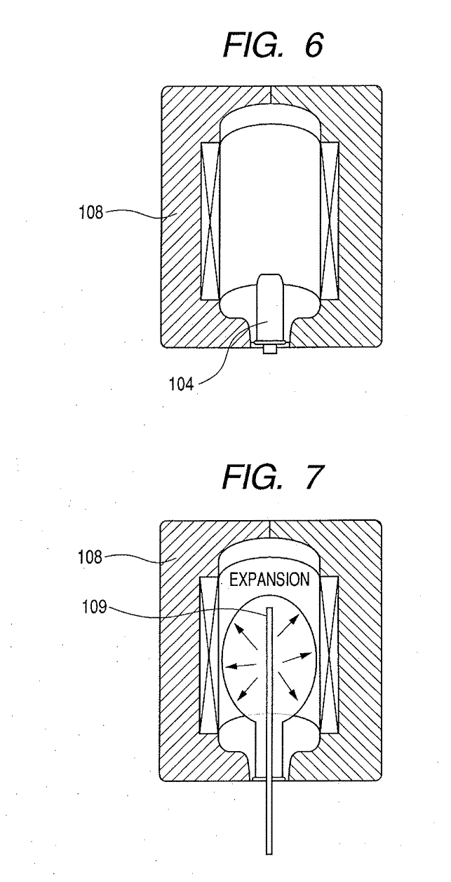

FIGS. 6 through 8 each are a diagram for illustrating a stretch blow molding step to be performed after the heating step.

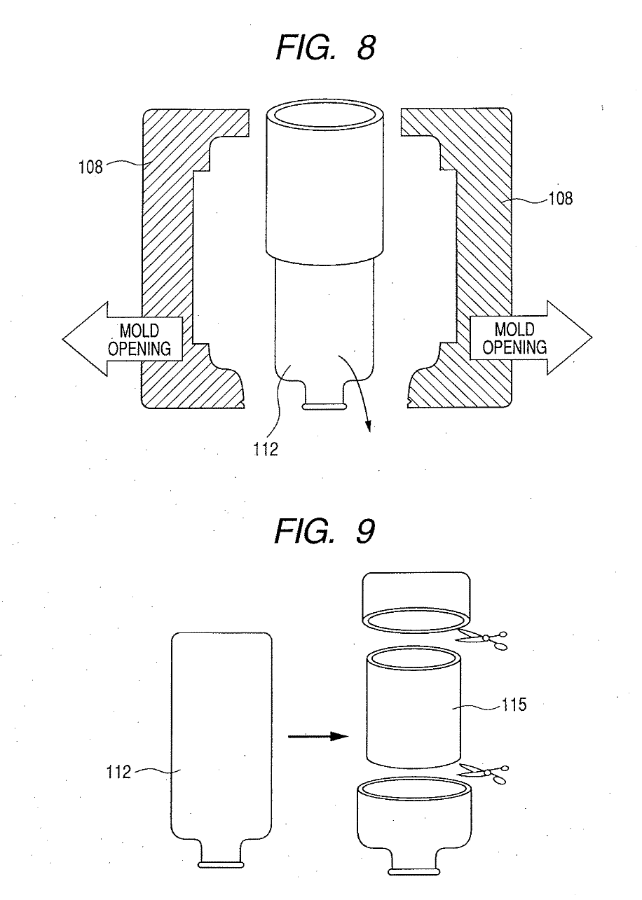

After the heating, the preform 104 is first stretched in the longitudinal direction inside the mold by a stretching rod 109 and a primary air pressure. Further, it expands along the inner surface of the mold due to a secondary air pressure. As shown in FIG. 8, after the expansion, the blow mold 108 is opened, and a stretch molding 112 is extracted. After the extraction, the upper and lower portions of the stretch molding 112 obtained are cut off as shown in FIG. 9, thereby making it possible to obtain an electrophotographic endless belt 115 according to the present invention.

Next, a specific example of the electrophotographic apparatus of the present invention will be described.

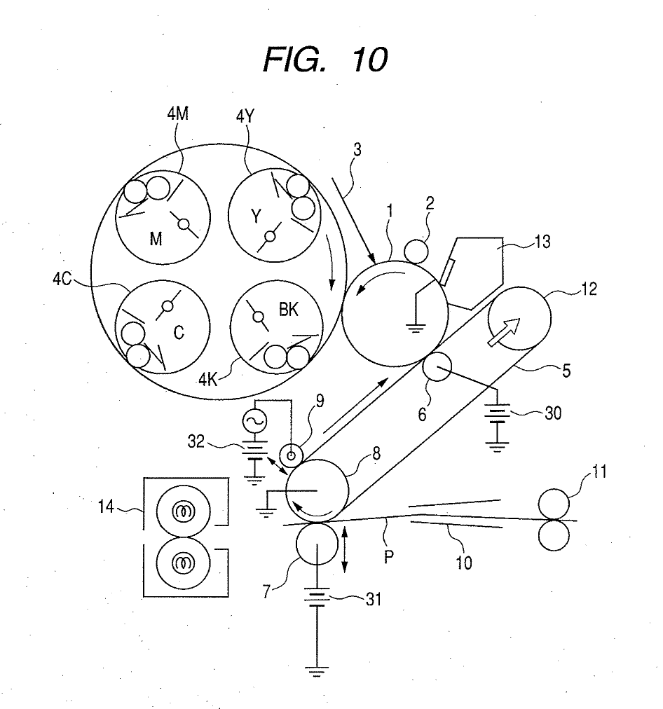

FIG. 10 schematically shows a construction example of a full-color electrophotographic apparatus using an electrophotographic endless belt according to the present invention as the intermediate transferring belt.

In FIG. 10, reference symbol 1 indicates a cylindrical electrophotographic photosensitive member, which is rotated in the direction of the arrow at a predetermined peripheral speed (processing speed).

During the rotation process, the surface of the electrophotographic photosensitive member 1 is charged by a primary charger (charging means) 2 to a predetermined polarity and potential. Thereafter, it receives an exposure light 3 from an image exposure device (exposure means (not shown)), there is thus formed an electrostatic latent image corresponding to a first color toner image of a target color image. Examples of the exposure method include slit exposure, laser beam scanning exposure, and LED exposure.

Next, the above-mentioned electrostatic latent image is developed by a first color toner Y of a first color developing device 4Y, and a first color toner image is formed on the surface of the electrophotographic photosensitive member 1. At this time, a second color developing device 4M, a third color developing device 4C, and a fourth color developing device 4K are operationally off, so they do not act on the electrophotographic photosensitive member 1. Thus, the above-mentioned first color toner image is not affected by the second color developing device 4M, the third color developing device 4C, and the fourth color developing device 4K.

An intermediate transferring belt 5 is run in the direction of the arrow at substantially the same peripheral speed as that of the electrophotographic photosensitive member 1 (e.g., not less than 97% but not more than 103% of the peripheral speed of the electrophotographic photosensitive member 1).

The first color toner image formed on the surface of the electrophotographic photosensitive member 1 is successively transferred to the surface of the intermediate transferring belt 5 (primary transfer) as it passes the contact portion (nip portion) between the electrophotographic photosensitive member 1 and the intermediate transferring belt 5. The primary transfer is effected by an electric field formed by a primary transfer bias applied from a primary transferring member (primary transferring roller) 6 to an intermediate transferring belt 5. The primary transfer bias is of an opposite polarity to the toner and is applied from a bias supply 30. The applied voltage is preferably in the range of not less than +100V but not more than 2 kV.

After the primary transfer, the surface of the electrophotographic photosensitive member 1 is cleaned by a cleaning device 13.

Thereafter, a second color toner image, a third color toner image, and a fourth color toner image are successively transferred in a similar fashion to the surface of the intermediate transferring belt 5, one superimposed upon the other, forming a synthetic color toner image corresponding to the target color image.

Reference symbol 7 indicates a secondary transferring member (secondary transferring roller), which is opposed to a secondary transfer opposing roller 8 so as to be borne in parallel thereto, and is provided so as to be capable of being separated from the lower surface portion of the intermediate transferring belt 5. Reference symbol 12 indicates a suspension roller. In the primary transfer of the first color toner image, the second color toner image, and the third color toner image from the electrophotographic photosensitive member 1 to the intermediate transferring belt 5, it is also possible to separate the secondary transferring member 7 from the intermediate transferring belt 5.

The synthetic color toner image transferred to the surface of the intermediate transferring belt 5 is transferred to a transfer material (paper or the like) P (secondary transfer). The secondary transfer is effected by an electric field formed by a secondary transfer bias applied to the intermediate transferring belt 5 from the secondary transferring member 7. The transfer material P is fed with a predetermined timing from sheet feeding rollers 11 through a transfer material guide 10 to a contact portion between the intermediate transferring belt 5 and the secondary transferring roller 7 in synchronism with the running of the intermediate transferring belt 5. The secondary transfer bias is applied from a bias supply 31, and the applied voltage is preferably in the range of not less than +100V but not more than +2 kV.

The transfer material P to which the synthetic color toner image has been transferred is introduced into a fixing device 14, in which the transfer material P undergoes fixing (heat fixing, etc.) before being output as a color image.

After the secondary transfer, a cleaning charging member 9 is held in contact with the intermediate transferring belt 5, and a bias of an opposite polarity to the electrophotographic photosensitive member 1 is applied thereto. As a result, a charge of an opposite polarity to the electrophotographic photosensitive member 1 is imparted to the toner (residual toner) remaining on the intermediate transferring belt 5 without being transferred to the transfer material P. Reference symbol 32 indicates a bias supply. In the contact portion between the intermediate transferring belt 5 and the electrophotographic photosensitive member 1 and in the vicinity thereof, the residual toner is electrostatically transferred from the intermediate transferring belt 5 to the electrophotographic photosensitive member 1, cleaning is thus effected on the intermediate transferring belt 5.

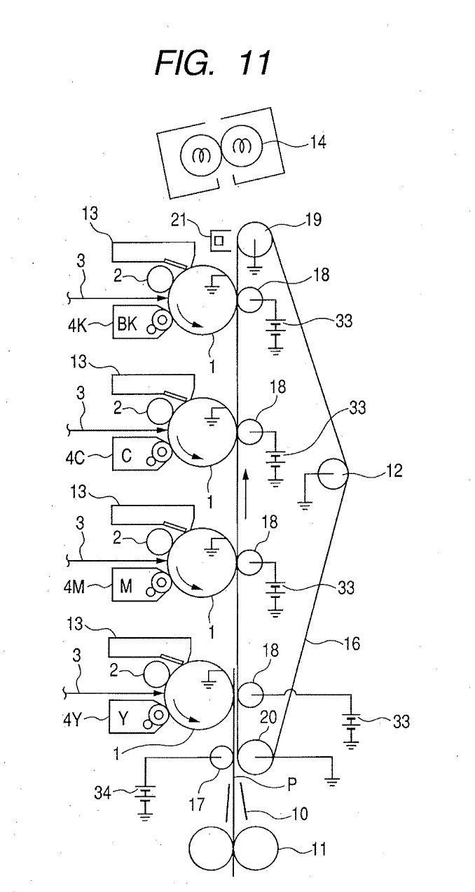

FIG. 11 schematically shows a construction example of a full-color electrophotographic apparatus using the electrophotographic endless belt of the present invention as the transfer material conveying belt.

In the electrophotographic apparatus shown in FIG. 11, four image forming portions are arranged side by side as the electrophotographic processing means. The image forming portion for the first color includes the electrophotographic photosensitive member 1, the primary charger 2, a first color developing device 4Y, and a cleaning device 13. The image forming portion for the second color includes the electrophotographic photosensitive member 1, the primary charger 2, a second color developing device 4M, and the cleaning device 13. The image forming portion for the third color includes the electrophotographic photosensitive member 1, the primary charger 2, a third color developing device 4C, and the cleaning device 13. The image forming portion for the fourth color includes the electrophotographic photosensitive member 1, the primary charger 2, a fourth color developing device 4K, and the cleaning device 13. The first color developing device 4Y, the second color developing device 4M, the third color developing device 4C, and the fourth color developing device 4K respectively accommodate a first color toner Y, a second color toner M, a third color toner C, and a fourth color toner K.

In the image forming portion for the first color, the surface of the electrophotographic photosensitive member 1 is charged during its rotation to a predetermined polarity and potential by the primary charger 2; thereafter, the electrophotographic photosensitive member 1 receives exposure light 3 from an image exposure device, thereby forming an electrostatic latent image corresponding to the first color toner image of the target color image. Examples of the exposure method include slit exposure, laser beam scanning exposure, and LED exposure.

Next, the above-mentioned electrostatic latent image is developed with the first color toner Y of the first color developing device 4Y, and the first color toner image is formed on the surface of the electrophotographic photosensitive member 1.

Also in the second color image forming portion, the third color image forming portion, and the fourth color image forming portion, a second color toner image, a third color toner image, and a fourth color toner image are respectively formed on the surfaces of the respective electrophotographic photosensitive members 1 of the image forming portions.

The toner images of the different colors formed on the surfaces of the respective electrophotographic photosensitive members 1 of the image forming portions are successively transferred, while one superimposed upon the other, to the transfer material P adhering to a transfer material conveying belt 16, and a synthetic color toner image corresponding to the target color image is formed. The transfer material P passes from the sheet feeding rollers 11 through the transfer material guide 10 to adhere to the transfer material conveying belt 16. The transfer is effected by an electric field formed by a transfer bias applied to the transfer material conveying belt 16 and the transfer material P from the transferring member 18. The transfer bias is of a polarity opposite to that of the toner and is applied from a bias supply 33; the applied voltage is preferably in the range of not less than +100V but not more than +2 kV.

The transfer material P to which the toner images of the different colors have been transferred undergoes charge elimination by a stripping charger 21, and is separated from the transfer material conveying belt 16 before being introduced into a fixing device 14, where the transfer material P undergoes fixing (heat fixing, etc.) before being output as a color image.

The transfer material conveying belt 16 is driven to run in the direction of the arrow at substantially the same peripheral speed as that of the respective electrophotographic photosensitive members 1 of the image forming portions (e.g., not less than 97% but not more than 103% with respect to the peripheral speed of the electrophotographic photosensitive members 1).

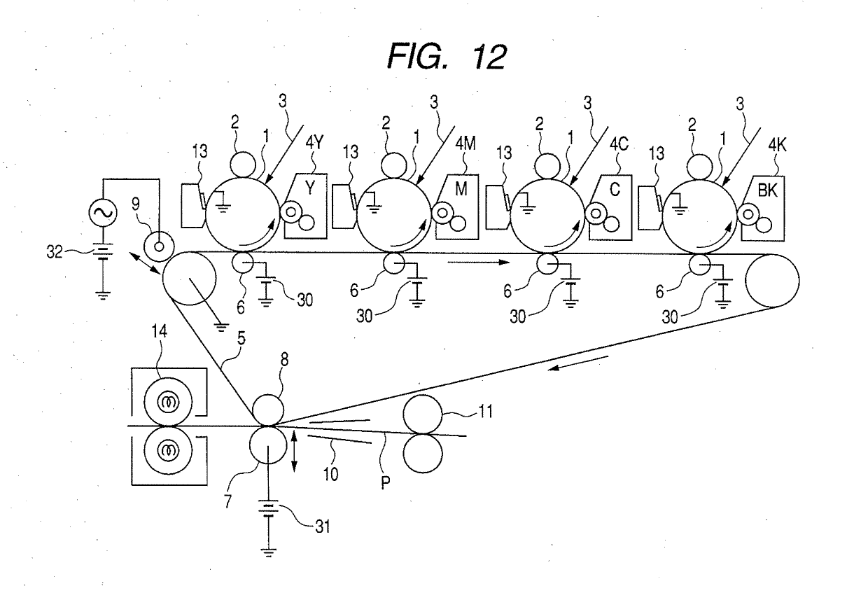

FIG. 12 schematically shows another construction example of a full-color electrophotographic apparatus using the electrophotographic endless belt of the present invention as the intermediate transferring belt.

In the electrophotographic apparatus shown in FIG. 12, four image forming portions are arranged side by side as the electrophotographic processing means. The image forming portion for the first color includes the electrophotographic photosensitive member 1, the primary charger 2, a first color developing device 4Y, and a cleaning device 13. The image forming portion for the second color includes the electrophotographic photosensitive member 1, the primary charger 2, a second color developing device 4M, and the cleaning device 13. The image forming portion for the third color includes the electrophotographic photosensitive member 1, the primary charger 2, a third color developing device 4C, and the cleaning device 13. The image forming portion for the fourth color includes the electrophotographic photosensitive member 1, the primary charger 2, a fourth color developing device 4K, and the cleaning device 13. The first color developing device 4Y, the second color developing device 4M, the third color developing device 4C, and the fourth color developing device 4K respectively accommodate a first color toner Y, a second color toner M, a third color toner C, and a fourth color toner K.

In the image forming portion for the first color, the surface of the electrophotographic photosensitive member 1 is charged during its rotation to a predetermined polarity and potential by the primary charger 2; thereafter, the electrophotographic photosensitive member 1 receives exposure light 3 from an image exposure device, thereby forming an electrostatic latent image corresponding to the first color toner image of the target color image. Examples of the exposure method include slit exposure, laser beam scanning exposure, and LED exposure.

Next, the above-mentioned electrostatic latent image is developed with the first color toner Y of the first color developing device 4Y, and a first color toner image is formed on the surface of the electrophotographic photosensitive member 1.

Also in the second color image forming portion, the third color image forming portion, and the fourth color image forming portion, a second color toner image, a third color toner image, and a fourth color toner image are respectively formed on the surfaces of the respective electrophotographic photosensitive members 1 of the image forming portions.

The toner images of the different colors formed on the surfaces of the respective electrophotographic photosensitive members 1 of the image forming portions are successively transferred, while one superimposed upon the other, to the surface of an intermediate transferring belt 5 (primary transfer), and a synthetic color toner image corresponding to the target color image is formed.

Reference symbol 7 indicates a secondary transferring member (secondary transferring roller), which is opposed to a secondary transfer opposing roller 8 so as to be borne in parallel thereto, and is arranged so as to be capable of being separated from the lower surface portion of the intermediate transferring belt 5.

The synthetic color toner image transferred to the surface of the intermediate transferring belt 5 is transferred to a transfer material (paper or the like) P (secondary transfer). The secondary transfer is effected by an electric field formed by a secondary transfer bias applied to the intermediate transferring belt 5 from the secondary transferring member 7. The transfer material P is fed with a predetermined timing from sheet feeding rollers 11 through a transfer material guide 10 to a contact portion between the intermediate transferring belt 5 and the secondary transferring roller 7 in synchronism with the running of the intermediate transferring belt 5. The secondary transfer bias is applied from a bias supply 31, and the applied voltage is preferably in the range of not less than +100V but not more than +2 kV.

The transfer material P to which the synthetic color toner image has been transferred is introduced into a fixing device 14, where the transfer material P undergoes fixing (heat fixing, etc.) before being output as a color image.

After the secondary transfer, a cleaning charging member 9 is held in contact with the intermediate transferring belt 5, and a bias of a polarity opposite to that of the electrophotographic photosensitive member 1 is applied thereto. As a result, a charge of a polarity opposite to that of the electrophotographic photosensitive member 1 is imparted to the toner (residual toner) remaining on the intermediate transferring belt 5 without being transferred to the transfer material P. Reference symbol 32 indicates a bias supply. In the contact portion between the intermediate transferring belt 5 and the electrophotographic photosensitive member 1 and in the vicinity thereof, the residual toner is electrostatically transferred from the intermediate transferring belt 5 to the electrophotographic photosensitive member 1, thereby effecting cleaning on the intermediate transferring belt 5.

As the combination of the first color toner, the second color toner, the third color toner, and the fourth color toner, a combination of yellow toner, magenta toner, cyan toner, and black toner is generally adopted.

In the following, the present invention will be described in more detail with reference to specific examples. However, the present invention is not limited thereto.

### EXAMPLE 1

Using a thermoplastic resin composition of the composition shown in Table 1, an electrophotographic endless belt with an average thickness of 150 μm (width: 280 mm, diameter: 140 mm) was prepared by the above-described stretch blow molding method. The thermoplastic resin composition used is a pelletized thermoplastic resin composition obtained by performing pelletization on a mixture of the materials shown in Table 1 by a biaxial extruder. The stretch magnification (stretch blow magnification) in the stretch blow molding step was: 4.4 times (the magnification in the radial direction of the test-tube-type preform: a)×2.5 times (the magnification in the direction perpendicular to the radial direction: b)=11 times.

### EXAMPLES 2 THROUGH 5 AND COMPARATIVE EXAMPLES 1 THROUGH 4

Using thermoplastic resin compositions of the compositions shown in Table 1, electrophotographic endless belts with average thicknesses as shown in Table 1 (width: 280 mm, diameter: 140 mm) were prepared by the above-described stretch blow molding method. As in Example 1, the thermoplastic resin compositions used in the examples are pelletized thermoplastic resin compositions obtained by performing pelletization on mixtures of the materials shown in Table 1 by a biaxial extruder.

TABLE 1

| | Thermoplastic resin composition | | | | | | | | |
|---|---|---|---|---|---|---|---|---|---|
| | Composition | | | | | | | | |
| | | | | | Perfluoro | | | | |
| | | | | | butane | | | Stretch | |
| | Polyethylene | Polyethylene | | Polyetherester | potassium | | Melting | magnification | Average |
| | terephthalate | naphthalate | Polypropylene | amide* | sulfonate | Total | point | (a × b) | thickness |
| | (mass %) | (mass %) | (mass %) | (mass %) | (mass %) | (mass %) | (° C.) | (times) | (μm) |
| Example 1 | 82.0 | — | — | 17.0 | 1.0 | 100.0 | 261 | 11.0 | 150 |
| | | | | | | | | (4.4 × 2.5) | |
| Example 2 | — | 80.0 | — | 19.5 | 0.5 | 100.0 | 266 | 10.0 | 140 |
| | | | | | | | | (4.0 × 2.5) | |
| Example 3 | — | 80.0 | — | 17.5 | 2.5 | 100.0 | 264 | 13.5 | 250 |
| | | | | | | | | (4.5 × 3.0) | |
| Example 4 | 82.0 | — | — | 17.5 | 0.5 | 100.0 | 260 | 11.0 | 110 |
| | | | | | | | | (4.4 × 2.5) | |
| Example 5 | 82.0 | — | — | 15.0 | 3.0 | 100.0 | 258 | 6.6 | 40 |
| | | | | | | | | (3.3 × 2.0) | |
| Comparative | — | — | 80.0 | 20.0 | — | 100.0 | 220 | 11.0 | 150 |
| Example 1 | | | | | | | | (4.4 × 2.5) | |
| Comparative | 82.0 | — | — | 17.0 | 1.0 | 100.0 | 261 | 4.0 | 150 |
| Example 2 | | | | | | | | (2.0 × 2.0) | |
| Comparative | — | — | 80.0 | 20.0 | — | 100.0 | 220 | 11.0 | 300 |
| Example 3 | | | | | | | | (4.4 × 2.5) | |
| Comparative | — | — | 80.0 | 20.0 | — | 100.0 | 220 | 11.0 | 30 |
| Example 4 | | | | | | | | (4.4 × 2.5) | |

*Irgastat P16 (trade name) manufactured by Ciba Specialty Chemicals

### (Measurement)

Measurement was performed on the electrophotographic endless belts of Examples 1 through 5 and Comparative Examples 1 through 4 for maximum tensile rupture distortion S and maximum heating shrinkage factor L (%).

Further, measurement was performed on the electrophotographic endless belts of Examples 1 through 5 and Comparative Examples 1 through 4 for volume resistivity and elastic modulus.

Table 2 shows the measurement results.

### (Evaluation)

Evaluation was made on the electrophotographic endless belts of Examples 1 through 5 and Comparative Examples 1 through 4 for peripheral length difference between the right-hand and left-hand openings. As the peripheral length difference between the right-hand and left-hand openings, the difference between the peripheral length as measured at 5 mm from the left-hand axial edge and the peripheral length as measured at 5 mm from the right-hand axial edge of the electrophotographic endless belt was adopted.

The evaluation standards for the peripheral length difference between the right-hand and left-hand openings are as follows:

A: The difference between the right-hand and left-hand peripheral lengths is 0.5 mm or less;
B: The difference between the right-hand and left-hand peripheral lengths is more than 0.5 mm but less than 1.0 mm;
C: The difference between the right-hand and left-hand peripheral lengths is not less than 1.0 mm but less than 2.0 mm; and
D: The difference between the right-hand and left-hand peripheral lengths is 2.0 mm or more.

### (None of the Examples Measured Fitted Into Class C).

Further, evaluation was made on the electrophotographic endless belts of Examples 1 through 5 and Comparative Examples 1 through 4 for the presence of a surface recess.

The evaluation standards for the presence of a surface recess are as follows:

A: No recess is to be observed;
B: While something like a recess is visible as a result of refraction of light, its presence cannot be ascertained by feeling; and
C: The presence of a recess can be ascertained both visually and to the touch.

Further, the electrophotographic endless belts of Examples 1 through 5 and Comparative Examples 1 through 4 were left to stand for three weeks in an environment of 40° C./90% RH, and then evaluation was made on them for electrical unevenness Vrmax/Vrmin. The greater the unevenness in the thickness of an electrophotographic endless belt, the greater the electrical unevenness Vrmax/Vrmin thereof tends to be.

The Vrmax/Vrmin was derived as follows.

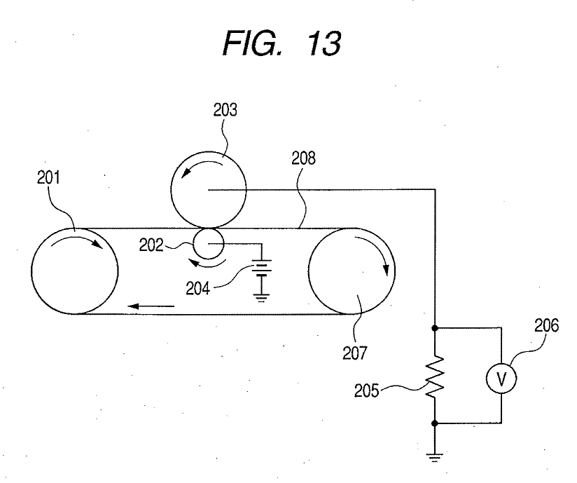

First, as shown in FIG. 13, an electrophotographic endless belt 208 was stretched between a driving roller 207 and a metal roller 201. Then, the electrophotographic endless belt 208 was nipped between two metal rollers 202 and 203, and a DC power source 204, a resistor 205 having a known resistance value, and a potentiometer 206 were connected thereto. The present inventors used, as the potentiometer 206, 87 TRUE RMS MULTI METER (trade name) manufactured by FLUKE, Co.

Next, by rotating the driving roller 207, the electrophotographic endless belt 208 was run such that the moving speed of its surface was 120 mm/s.

Then, a DC voltage of +1 kV was applied to the circuit from the DC power source 204 for five seconds, and the difference in potential Vr across the resistor 205 at that time was read from the potentiometer 206. In this regard, the maximum value of the potential difference Vr is referred to as Vrmax, the minimum value thereof as Vrmin, and the average value thereof as Vrave. By dividing Vrmax by Vrmin, it is possible to obtain Vrmax/Vrmin. The measurement environment was as follows: 23±2° C./60±10% RH.

The evaluation standards for Vrmax/Vrmin are as follows:

A: 1.3 or less;
B: more than 1.3 but not more than 1.6; and
C: more than 1.6.

Each of the electrophotographic endless belts of Examples 1 through 4 and Comparative Examples 1 through 4 was attached to an electrophotographic apparatus constructed as shown in FIG. 11 as the transfer material conveying belt, and a successive image output test using 10000 A4-size sheets was conducted in an environment of 40° C./90% RH. Then, blue character images and line images using cyan and magenta, and green character images and line images using cyan and yellow were output by using 80 g/m² sheets to make evaluation regarding color drift.

Further, the electrophotographic endless belt of Example 5 was attached to an electrophotographic apparatus constructed as shown in FIG. 12 as the intermediate transferring belt, and a successive image output test using 10000 A4-size sheets was conducted in an environment of 40° C./90% RH. Then, blue character images and line images using cyan and magenta, and green character images and line images using cyan and yellow were output by using 80 g/m² sheets to make evaluation regarding color drift.

The evaluation standards for color drift are as follows:

A: satisfactory;
B: nearly satisfactory; and
C: not satisfactory.

Table 2 shows the results of the above evaluation.

TABLE 2

| | | | | | | Difference | | | |
|---|---|---|---|---|---|---|---|---|---|
| | | | | | | in | | | |
| | | | | | | peripheral | | | |
| | | | | | | length | | | |
| | | Maximum | | | | between | | | |
| | Maximum | heating | | | | right-hand | | | |
| | tensile | shrinkage | | Volume | Elastic | and left- | | | |
| | rupture | factor L | | resistivity | modulus | hand | Surface | Vrmax/ | Color |
| | distortion | (%) | (S + 1)/L | (Ω · cm) | (MPa) | openings | recess | Vrmin | drift |
| Example 1 | 6.3 | 56 | 0.13 | 2.0 × 10¹⁰ | 1710 | A | A | A | A |
| | (at 90° C.) | (at 281° C.) | | | | | | | |
| Example 2 | 6.3 | 66 | 0.11 | 2.3 × 10¹¹ | 1650 | A | A | A | A |
| | (at 160° C.) | (at 296° C.) | | | | | | | |
| Example 3 | 2.0 | 25 | 0.12 | 1.1 × 10¹⁰ | 1970 | A | A | B | B |
| | (at 150° C.) | (at 294° C.) | | | | | | | |
| Example 4 | 12.6 | 80 | 0.17 | 8.0 × 10¹¹ | 1340 | B | B | A | B |
| | (at 100° C.) | (at 280° C.) | | | | | | | |
| Example 5 | 0.5 | 15 | 0.10 | 2.2 × 10¹² | 1220 | B | B | B | B |
| | (at 90° C.) | (at 278° C.) | | | | | | | |
| Comparative | 0.8 | 90 | 0.02 | 1.2 × 10¹¹ | 520 | D | C | C | C |
| Example 1 | (at 130° C.) | (at 260° C.) | | | | | | | |
| Comparative | 1.0 | 10 | 0.20 | 4.3 × 10¹⁴ | 770 | D | C | C | C |
| Example 2 | (at 130° C.) | (at 281° C.) | | | | | | | |
| Comparative | 2.4 | 85 | 0.04 | 7.8 × 10¹¹ | 1350 | D | C | C | C |
| Example 3 | (at 130° C.) | (at 260° C.) | | | | | | | |
| Comparative | 0.6 | 82 | 0.02 | 7.9 × 10¹¹ | 400 | D | C | C | C |
| Example 4 | (at 130° C.) | (at 260° C.) | | | | | | | |

This application claims priority from Japanese Patent Application No. 2004-359884 filed on Dec. 13, 2004, which is hereby incorporated by reference herein.

1. An electrophotographic endless belt formed of a thermoplastic resin composition, characterized in that:
assuming that a maximum heating shrinkage factor when a slice of the electrophotographic endless belt is hot-pressed in a temperature range higher than a melting point of the thermoplastic resin composition by 10° C. to 120° C. is L (%), 15≦L≦80 is established; and
assuming that a maximum tensile rupture distortion attained by performing a heating tensile test using a slice hot-pressed at a temperature giving the maximum heating shrinkage factor in a temperature range of 80° C. to 200° C. is S, 0.10≦(S+1)/L≦0.17 is established.

2. The electrophotographic endless belt according to claim 1, characterized in that the thermoplastic resin composition contains a thermoplastic resin and an ionic conductive high molecular compound.

3. The electrophotographic endless belt according to claim 1, characterized in that the electrophotographic endless belt has an average thickness of not less than 40 μm but not more than 250 μm.

4. An electrophotographic apparatus comprising an electrophotographic endless belt as claimed in claim 1.

5. The electrophotographic apparatus according to claim 4, characterized in that the electrophotographic endless belt is a transfer material conveying belt.

6. The electrophotographic apparatus according to claim 4, characterized in that the electrophotographic endless belt is an intermediate transferring belt.

7. An electrophotographic endless belt manufacturing method for manufacturing an electrophotographic endless belt as claimed in claim 1, comprising a step of conducting stretch blow molding by using the thermoplastic resin composition.
